(19) United States
(12) Patent Application Publication
(10) Pub. No.: US 2009/0089747 A1
(43) Pub. Date: Apr. 2, 2009

(54) METHOD AND SYSTEM FOR MANAGING CONFIGURATION INFORMATION

(75) Inventors: Atul A. Namjoshi, Tampa, FL (US); Jeffrey C. Cohen, Rockville, MD (US); Sandeep S. Nadkarni, Columbia, MD (US)

Correspondence Address: VERIZON;PATENT MANAGEMENT GROUP, 1320 North Court House Road, 9th Floor, ARLINGTON, VA, 22201-2909, US

(73) Assignees: Verizon Data Services Inc., Temple Terrace, FL (US); Verizon Services Corp., Arlington, VA (US)

(21) Appl. No.: 11/852,021

(22) Filed: Sep. 7, 2007

(51) Int. Cl. G06F 9/44

(52) U.S. Cl. 717/115

(57) ABSTRACT

An approach is provided for managing a software environment. A system file that includes information of a software environment is built. The system file is validated against one or more rules. A script is output and used to generate standardized configuration information for the software environment.

### BACKGROUND INFORMATION

In addition to other responsibilities, software engineers (or application teams) within an enterprise, for instance, are tasked with changing and managing the configuration of various software environments and products. These practices are in place to enable effective use of the software, while ensuring that the software conforms to the requirements of the users within the enterprise. Depending upon the complexity of the changes and the application architecture, a new package build can require a rather lengthy period to effect. In the current times of “speed to market,” it is clearly necessary to cut down the package creation and testing time so that a configuration such as that associated with an application server gets deployed as quickly as possible. Software development and management can involve multiple handoffs among various entities. As such, the requirements can be communicated inaccurately to the applications team, requiring additional time for the final package delivery. Furthermore, the development process can introduce a bottleneck if highly specialized knowledge is needed to carry out certain tasks, in that such specialized skill is often scarce.

Based on the foregoing, there is a clear need for efficiently managing configuration information.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of an application configuration platform, according with an exemplary embodiment;

FIG. 2 is a diagram of a configuration tool utilized in the application configuration platform of FIG. 1;

FIG. 3 is a diagram of exemplary programs provided by the configuration tool of FIG. 2;

FIGS. 4A and 4B is a flowchart of a process converting a system file into a script, according to an exemplary embodiment; and

FIG. 5 is a diagram of a computer system that can be used to implement various exemplary embodiments.

### DETAILED DESCRIPTION OF PREFERRED EMBODIMENTS

A method and system for managing a software environment is described. In the following description, for the purposes of explanation, numerous specific details are set forth in order to provide a thorough understanding of the various exemplary embodiments. It is apparent, however, that the various exemplary embodiments may be practiced without these specific details or with an equivalent arrangement. In other instances, well-known structures and devices are shown in block diagram form in order to avoid unnecessarily obscuring the exemplary embodiments.

Although the various embodiments are described with respect to a JAVA™-based platform and server configurations, it is contemplated that these embodiments have applicability to other equivalent software platforms and configurations of other network elements.

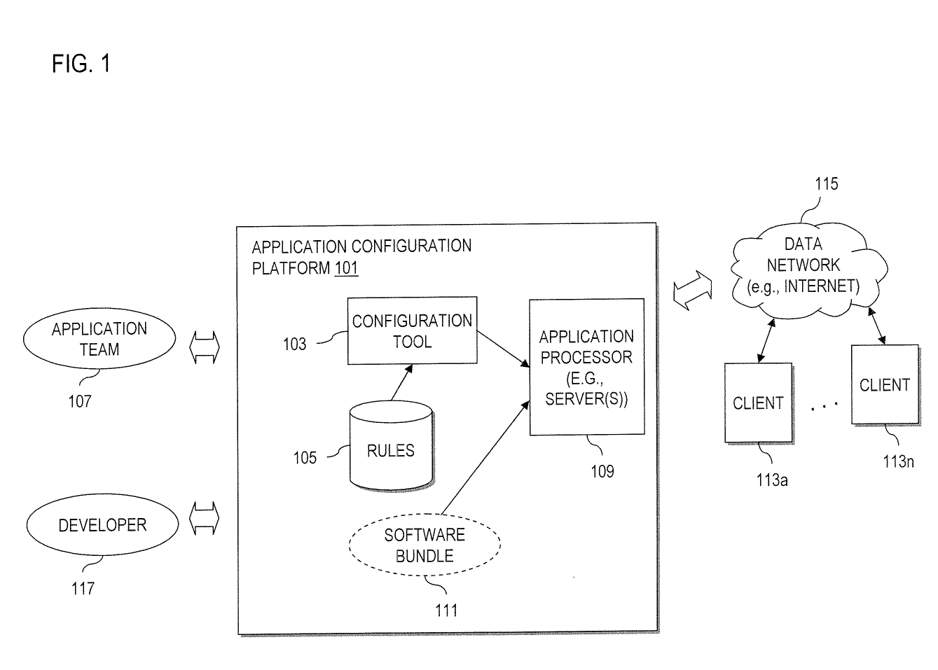

FIG. 1 is a diagram of an application configuration platform, according with an exemplary embodiment. For the purposes of illustration, an application configuration platform 101 is explained in the context of an enterprise application. The application configuration platform 101 includes a configuration tool 103 that permits development of applications without requiring knowledge of specialized programming languages. Additionally, the configuration tool 103 ensures uniformity and standardization of applications, using a rules database 105. These rules, for instance, can be set based on policies of the organization (e.g., service provider, enterprise, department, etc.). According to one embodiment, the configuration tool 103 has the capability to allow an application team 107 within an enterprise to efficiently configure their application processor 109 (e.g., one or more servers) directly without the need to request other entities within the enterprise to create software bundles 111 for the team 107.

An application server 109 is an example of such a software environment that can be configured based on the requirements of a software team (i.e., application team 107). The typical procedure for configuring application servers is to create software bundles that can deploy application server configuration to non-production and production environments. The packages ensure that key configuration properties, such as log file names and locations, are not changed and follow a consistent schema. This is important since all server installations within the organization have to maintain an identical look from an operational perspective. The organization needs to ensure that security and performance issues are properly managed. The environment specific information, such as database usernames and passwords, are retrieved from a system specific information (SSI) file, while these packages are being deployed.

It is recognized that to enable the application team 107 to directly manage the server configuration for their application instead of creating software bundles for them, some concerns need to addressed. First, maintaining uniformity across the enterprise for all server installations is necessary for smooth day to day operations, as well as improving mean time to recovery during a crisis outage. If an application team is allowed to manage the configuration directly, there is no mechanism to guarantee that the server configuration standards will be followed across the board which has, and would, delay recovery of an application in production and negatively impact users.

Secondly, it is noted that conventional approaches are lacking in capability. Considering that the application teams will, in many an occasion, be unable to effectively manage the configuration through a graphical user interface, other options are clearly needed as such graphical interfaces typically provide only restricted access to server configuration resources due to firewalls. Also, replicating the same configuration from one environment to another cannot be readily automated with this method.

Another option is to use command line utilities, such as scripting tools; however, this approach generally requires the application teams to have extensive knowledge in a specific programming language as well as the use of various other complicated software components. Furthermore, these scripting tools can require the use of proprietary syntax; and thus, customizing them to suit the standard of an enterprise can be a complex process.

As seen in FIG. 1, the processor 109 provides resources, such as applications, to clients 113a-113n, which may be internal or external to the enterprise over a data network 115. The data network 115 may be an internetwork, such as the global Internet. Conventionally, the process for configuring the application processor 109 involves the application team 107, requesting a developer 117 to create a software bundle 111 based on the requirements of the application team 107. As used herein, the developer 117 refers to the human agent(s) and/or hardware/software environment. As described previously, the drawback of this conventional approach of creating tailored software bundles is that creation and testing of the software bundle 111 require significant time (i.e., delay). Further, requirements from the application team 107 are oftentimes communicated inaccurately, resulting in multiple iterations of the software bundle development lifecycle.

By contrast to the conventional approach, the platform 101 permits the application team 107 to directly configure the application processor 109 via the configuration tool 103. This eliminates the need for generating a software bundle 111 by the developer 117, and speeds up the configuration cycle of the application processor 109.

For the purposes of explanation, the application configuration platform 101 provides a JAVA™-based platform, such as WebLogic by BEA Systems, Inc. It is contemplated, however, that other software environments can be utilized. In this example, the application processor 109 of FIG. 1 may be JAVA™ 2 Enterprise Edition (J2EE) application server—e.g., WebLogic server. In this context, the software bundle 111 created by developer 117 may be referred to as a system V package, although other conventions are also possible.

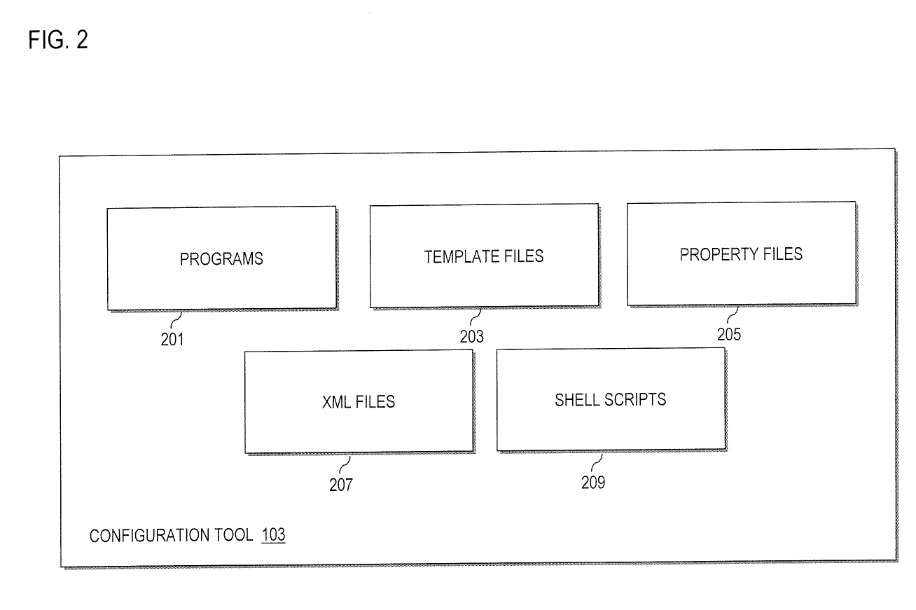

By way of example, the configuration tool 103 configures the WebLogic server 109 according to a scripting environment (e.g., WebLogic Scripting Tool (WLST)). FIG. 2 depicts the various components of the configuration tool 103.

FIG. 2 is a diagram of a configuration tool utilized in the application configuration platform of FIG. 1. As shown, the configuration tool 103, in an exemplary embodiment, encompasses one or more programs 201, such as those developed in JAVA™ for accomplishing the various processes for providing configuration of the application server 109. In addition, the programs 201 can include template files 203 that define standard user names, passwords, user roles etc. Property files 205 are also included for specifying variables and their values that are required by one or more of the programs 201.

Additionally, the configuration tool 103 includes XML (Extensible Markup Language) files 207 that contain items such as rules against which other files are validated against as well as configuration information specified by the application team 107. Such rules ,for instance, can be derived from the rules database 105. Table 1, below, enumerates exemplary rules:

TABLE 1
RULES

Disable WebLogic Managed server broadcasting log messages to domain
log
NativeIO is true
Log file name should be “xxxx_access.log”
Disable WebLogic banner

According to one embodiment, two types of scripts are utilized: shell scripts 209 for permitting a single command to execute program components (i.e., macro); and scripts output from the code builder program. The shell scripts 209 can be based on the Unix operating environment. The scripts can be Jython scripts, which are automatically by the code builder program based on the XML configuration file 207 (supplied by the application team 107 in form of a SSI file).

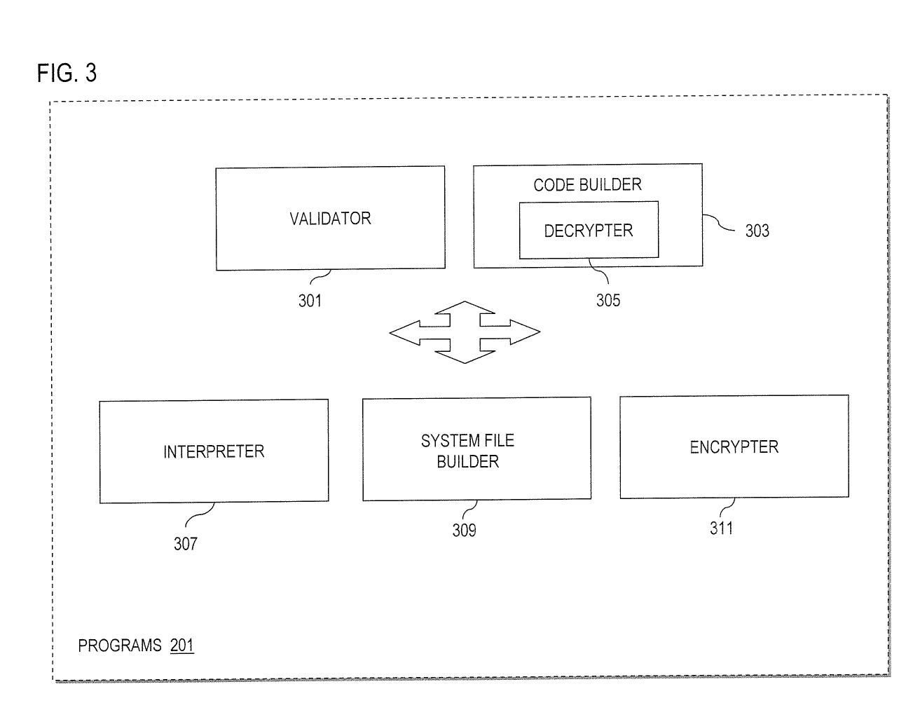

FIG. 3 is a diagram of exemplary programs provided by the configuration tool of FIG. 2. Under this scenario, the following program/processes are included in the programs 201: a validator 301, a code builder 303 (which includes a decrypter 305), an interpreter 307, a system file builder 309, and an encrypter 311. For example, the validator 301 checks a system file (e.g., build SSI file) against a set of predetermined standards and rules. The build SSI file can based on a format such as XML; and the Weblogic domain configuration can be also specified in XML format within this SSI file. Another program includes the code builder 303, which automatically generates (or outputs) scripts (e.g., Jython scripts) in response to an input build SSI file.

As the name indicates, the interpreter 307 interprets the script (e.g., Jython script) for ultimately generating a Weblogic domain and its configuration. In an exemplary embodiment, the interpreter 307 is a WLST, which is a command-line interpreter.

The system file builder 309 is a program that converts an XML configuration file into a build system file that is to be validated by the validator program 301. The encrypter 311 is used to encrypt passwords within the build SSI files. The encrypted passwords can be substituted in the build SSI file. Decryption can be performed by the decrypter 305.

It is contemplated that any one of the processes 301-311 can be implemented as standalone processes, or combined in various combinations. For instance, the encrypter 311 and the decrypter 305 can be made into a single program.

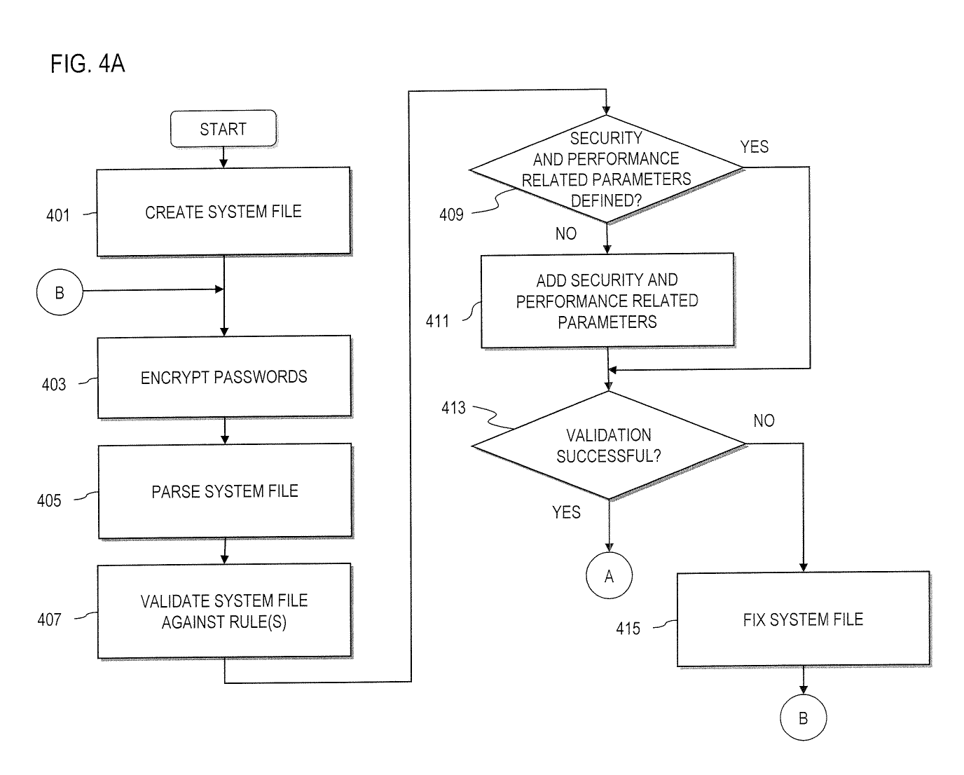

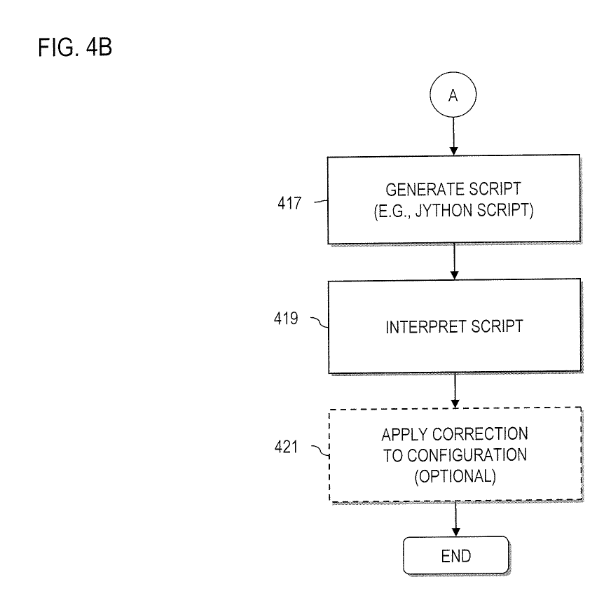

FIGS. 4A and 4B is a flowchart of a process converting a system file into a script, according to an exemplary embodiment. In step 401, the application team 107 creates a system file (e.g., a build SSI file), which lists all the components and their properties that need to be created within the Weblogic environment. In an exemplary embodiment, the SSI file is based on XML format and has easy to understand tags. Table 2 shows an exemplary input XML file:

```
TABLE 2
<?xml version=“1.0” encoding=“UTF-8”?>
<WL-Domain-Config Name=“ABCD” Version=“8.1” Type=“Server”>
  <MBean Action=“Create” Name=“ABCD_CLUSTER” Type=“Cluster”>
    <Property Name=“ClusterAddress” Value=“122.122.122.122:2111,122.122.122.122:1221”/>
    <Property Name=“DefaultLoadAlgorithm” Value=“round-robin”/>
    <Property Name=“MulticastAddress” Value=“12.12.12.12”/>
  </MBean>
  <MBean Action=“Create” Name=“adminserver” Type=“Server”>
    <Property Name=“ListenPort” Value=“2112”/>
    <Property Name=“ListenAddress” Value=“122.122.122.122”/>
  </MBean>
  <MBean Action=“Create” Name=“managed1” Type=“Server”>
    <Property Name=“ListenPort” Value=“2111”/>
    <Property Name=“ListenAddress” Value=“122.122.122.122”/>
    <Property Name=“Cluster” Value=“ABCD_CLUSTER”/>
    <SubMBean Name=“default” Type=“ExecuteQueue”>
      <Property Name=“ThreadCount” Value=“30”/>
    </SubMBean>
  </MBean>
  <MBean Action=“Create” Name=“managed2” Type=“Server”>
    <Property Name=“ListenPort” Value=“1221”/>
    <Property Name=“ListenAddress” Value=“122.122.122.122”/>
    <Property Name=“Cluster” Value=“ABCD_CLUSTER”/>
    <SubMBean Name=“default” Type=“ExecuteQueue”>
      <Property Name=“ThreadCount” Value=“30”/>
    </SubMBean>
  </MBean>
  <MBean Action=“Create” Name=“XYZ Mail Session” Type=“MailSession”>
    <Property Name=“JNDIName” Value=“mail/VNMMail”/>
    <Property Name=“Properties”
Value=“mail.from=test.x.myself@acme.com;mail.transport.protocol=smtp;mail.smtp.host=xmtp.acme.com”/>
    <Property Name=“Targets” Value=“managed1,managed2”/>
  </MBean>
</WL-Domain-Config>
```

Optionally, the application team 107 can reengineer the build SSI file from an existing Weblogic configuration file using the SSI Builder program 309. The build SSI file can be assigned a predefined name and have a root element that has a limited number of attributes (e.g., name and version attributes).

The passwords listed in the build file are then encrypted in step 403 using, for instance, 3DES (Data Encryption Standard) format. This password encryption procedure can be specified as part of a security policy of an organization. Traditional systems provide passwords in clear text within the build SSI file, which is a security risk.

The build SSI file is then parsed in step 405 and validated in step 407 against a predefined set of rules contained within an XML rules file by the validator program 301. The next step involves determining whether important security and performance related parameters are defined (step 409). If undefined, these parameters are added to the validated build SSI file, as in step 411.

Next, the process determines whether the validation is successful, per step 413.

If the parameters have already been defined, the validated file is checked for any errors. If any severe errors are encountered, the process aborts. The determination of the “severity” or degree of error can be specified in policies of the enterprise. In this case, the application team 107 is instructed to fix the build SSI file, as in step 415. The validator program 301 also flags any inconsistencies and updates the SSI file wherever necessary.

If the validation on the build SSI file is indeed successful, then the build SSI file is fed to the code builder 303 of FIG. 3, as in step 417, which generates a script. Table 3 illustrates a validated version of the input file of Table 2:

```
TABLE 3
<?xml version=“1.0” encoding=“UTF-8”?>
<WL-Domain-Config Name=“ABCD” Type=“Server” Version=“8.1”>
  <MBean Action=“Create” Name=“ABCD_CLUSTER” Type=“Cluster”>
    <Property Name=“ClusterAddress” Value=“122.122.122.122:2111,122.122.122.122:1221”/>
    <Property Name=“DefaultLoadAlgorithm” Value=“round-robin”/>
    <Property Name=“MulticastAddress” Value=“12.12.12.12”/>
  </MBean>
  <MBean Action=“Create” Name=“adminserver” Type=“Server”>
    <Property Name=“TransactionLogFilePrefix” Value=“config/ABCD/TLOGs/”/>
    <Property Name=“NativeIOEnabled” Value=“true”/>
    <Property Name=“EnabledForDomainLog” Value=“false”/>
    <Property Name=“MSIFileReplicationEnabled” Value=“false”/>
    <Property Name=“ManagedServerIndependenceEnabled” Value=“false”/>
    <Property Name=“ListenPort” Value=“2112”/>
    <Property Name=“ListenAddress” Value=“122.122.122.122”/>
    <SubMBean Action=“Create” Name=“adminserver” Type=“WebServer”>
      <Property Name=“SendServerHeaderEnabled” Value=“false”/>
      <Property Name=“MaxLogFileSizeKBytes” Value=“0”/>
      <Property Name=“LoggingEnabled” Value=“true”/>
      <Property Name=“LogFileName” Value=“/apps/opt/weblogic/config/ABCD/logs/adminserver_access.log”/>
    </SubMBean>
    <SubMBean Action=“Create” Name=“adminserver” Type=“Log”>
      <Property Name=“RotationType” Value=“none”/>
      <Property Name=“FileName” Value=“/apps/opt/weblogic/config/ABCD/logs/adminserver.log”/>
    </SubMBean>
  </MBean>
  <MBean Action=“Create” Name=“managed1” Type=“Server”>
    <Property Name=“TransactionLogFilePrefix” Value=“config/ABCD/TLOGs/”/>
    <Property Name=“NativeIOEnabled” Value=“true”/>
    <Property Name=“EnabledForDomainLog” Value=“false”/>
    <Property Name=“MSIFileReplicationEnabled” Value=“false”/>
    <Property Name=“ManagedServerIndependenceEnabled” Value=“false”/>
    <Property Name=“ListenPort” Value=“2111”/>
    <Property Name=“ListenAddress” Value=“122.122.122.122”/>
    <Property Name=“Cluster” Value=“ABCD_CLUSTER”/>
    <SubMBean Action=“Create” Name=“default” Type=“ExecuteQueue”>
      <Property Name=“ThreadCount” Value=“30”/>
    </SubMBean>
    <SubMBean Action=“Create” Name=“managed1” Type=“WebServer”>
      <Property Name=“SendServerHeaderEnabled” Value=“false”/>
      <Property Name=“MaxLogFileSizeKBytes” Value=“0”/>
      <Property Name=“LoggingEnabled” Value=“true”/>
      <Property Name=“LogFileName” Value=“/apps/opt/weblogic/config/ABCD/logs/managed1_access.log”/>
    </SubMBean>
    <SubMBean Action=“Create” Name=“managed1” Type=“Log”>
      <Property Name=“RotationType” Value=“none”/>
      <Property Name=“FileName” Value=“/apps/opt/weblogic/config/ABCD/logs/managed1.log”/>
    </SubMBean>
  </MBean>
  <MBean Action=“Create” Name=“managed2” Type=“Server”>
    <Property Name=“TransactionLogFilePrefix” Value=“config/ABCD/TLOGs/”/>
    <Property Name=“NativeIOEnabled” Value=“true”/>
    <Property Name=“EnabledForDomainLog” Value=“false”/>
    <Property Name=“MSIFileReplicationEnabled” Value=“false”/>
    <Property Name=“ManagedServerIndependenceEnabled” Value=“false”/>
    <Property Name=“ListenPort” Value=“1221”/>
    <Property Name=“ListenAddress” Value=“122.122.122.122”/>
    <Property Name=“Cluster” Value=“ABCD_CLUSTER”/>
    <SubMBean Action=“Create” Name=“default” Type=“ExecuteQueue”>
      <Property Name=“ThreadCount” Value=“30”/>
    </SubMBean>
    <SubMBean Action=“Create” Name=“managed2” Type=“WebServer”>
      <Property Name=“SendServerHeaderEnabled” Value=“false”/>
      <Property Name=“MaxLogFileSizeKBytes” Value=“0”/>
      <Property Name=“LoggingEnabled” Value=“true”/>
      <Property Name=“LogFileName” Value=“/apps/opt/weblogic/config/ABCD/logs/managed2_access.log”/>
    </SubMBean>
    <SubMBean Action=“Create” Name=“managed2” Type=“Log”>
      <Property Name=“RotationType” Value=“none”/>
      <Property Name=“FileName” Value=“/apps/opt/weblogic/config/ABCD/logs/managed2.log”/>
    </SubMBean>
  </MBean>
  <MBean Action=“Create” Name=“XYZ Mail Session” Type=“MailSession”>
    <Property Name=“JNDIName” Value=“mail/XYZMail”/>
    <Property Name=“Properties”
Value=“mail.from=test.x.myself@acme.com;mail.transport.protocol=smtp;mail.smtp.host=xmtp.acme.com”/>
    <Property Name=“Targets” Value=“managed1,managed2”/>
  </MBean>
  <MBean Action=“Update” Name=“ABCD” Type=“Log”>
    <Property Name=“RotationType” Value=“none”/>
    <Property Name=“FileName” Value=“/apps/opt/weblogic/config/ABCD/ABCD.log”/>
  </MBean>
</WL-Domain-Config>
```

In one embodiment, the script is output according to the Jython scripting language based on the validated XML file. Since this script is generated automatically, this negates the need for the application team 107 to possess expert knowledge of Jython and other software components such as MBeans (management beans), thereby permitting the team 107 to focus on the application code. The code builder 303 utilizes a properties file 205 of FIG. 2 that contains various variables and their values which are required by the code builder program.

Continuing with the example of Table 2, the output Jython script is shown in Table 4, as follows:

```
TABLE 4
from java.lang import UnsupportedOperationException
from com.bea.plateng.domain.script.jython import WLSTException
from java.util import Properties
from jarray import array
from weblogic.management.configuration import JDBCConnectionPoolMBean
from weblogic.management.configuration import ServerMBean
print ‘Reading template : /apps/opt/weblogic/scripts/templates/wls81.jar’
readTemplate(‘/apps/opt/weblogic/scripts/templates/wls81.jar’)
cd(‘/’)
###
# Create MailSession - XYZ Mail Session
###
def Create_XYZ_Mail_Session_MailSession_Func( ):
  print ‘Creating MailSession = XYZ Mail Session’
  XYZ_Mail_Session_MailSession_Obj = None
  try:
    XYZ_Mail_Session_MailSession_Obj = cd(‘MailSessions/XYZ Mail Session’)
  except UnsupportedOperationException, usoe:
    pass
  except WLSTException, wlse:
    pass
  if XYZ_Mail_Session_MailSession_Obj == None:
    try:
      XYZ_Mail_Session_MailSession_Obj = create(‘XYZ Mail Session’,‘MailSession’)
      print ‘MailSession - XYZ Mail Session created.’
    except UnsupportedOperationException, usoe:
      pass
    except WLSTException, wlse:
      pass
  else:
    print ‘MailSession - XYZ Mail Session exists.’
  print ‘Setting JNDIName = mail/XYZMail for MailSession - XYZ Mail Session’
  XYZ_Mail_Session_MailSession_Obj.setJNDIName(‘mail/XYZMail’)
```

| | | | |
|---|---|---|---|
| print | ‘Setting | Properties | = |

```
mail.from=test.x.myself@acme.com;mail.transport.protocol=smtp;mail.smtp.host=xmtp.acme.com for MailSession -
XYZ Mail Session’
  propobj = Properties( )
  propobj.setProperty(‘mail.from’,‘test.x.myself@acme.com’)
  propobj.setProperty(‘mail.transport.protocol’,‘smtp’)
  propobj.setProperty(‘mail.smtp.host’,‘xmtp.acme.com’)
  XYZ_Mail_Session_MailSession_Obj.setProperties(propobj)
  cd(‘/’)
  cd(‘/’)
  return XYZ_Mail_Session_MailSession_Obj
###
# Create Server - adminserver
###
def Create_adminserver_Server_Func( ):
  print ‘Creating Server = adminserver’
  adminserver_Server_Obj = None
  try:
    adminserver_Server_Obj = cd(‘Servers/adminserver’)
  except UnsupportedOperationException, usoe:
    pass
  except WLSTException, wlse:
    pass
  if adminserver_Server_Obj == None:
    try:
      adminserver_Server_Obj = create(‘adminserver’,‘Server’)
      print ‘Server - adminserver created.’
    except UnsupportedOperationException, usoe:
      pass
    except WLSTException, wlse:
      pass
  else:
    print ‘Server - adminserver exists.’
  print ‘Setting TransactionLogFilePrefix = config/ABCD/TLOGs/ for Server - adminserver’
  adminserver_Server_Obj.setTransactionLogFilePrefix(‘config/ABCD/TLOGs/’)
  print ‘Setting NativeIOEnabled = 1 for Server - adminserver’
  adminserver_Server_Obj.setNativeIOEnabled(1)
  print ‘Setting EnabledForDomainLog = 0 for Server - adminserver’
  adminserver_Server_Obj.setEnabledForDomainLog(0)
  print ‘Setting MSIFileReplicationEnabled = 0 for Server - adminserver’
  adminserver_Server_Obj.setMSIFileReplicationEnabled(0)
  print ‘Setting ManagedServerIndependenceEnabled = 0 for Server - adminserver’
  adminserver_Server_Obj.setManagedServerIndependenceEnabled(0)
print ‘Setting ListenPort = 2112 for Server - adminserver’
  adminserver_Server_Obj.setListenPort(2112)
  print ‘Setting ListenAddress = 122.122.122.122 for Server - adminserver’
  adminserver_Server_Obj.setListenAddress(‘122.122.122.122’)
cd(‘/’)
  cd(‘/Server/adminserver’)
  print ‘Creating WebServer = adminserver for Server - adminserver’
  adminserver_WebServer_Obj = None
  try:
    adminserver_WebServer_Obj = cd(‘WebServers/adminserver’)
  except UnsupportedOperationException, usoe:
    pass
  except WLSTException, wlse:
    pass
  if adminserver_WebServer_Obj == None:
    try:
      adminserver_WebServer_Obj = create(‘adminserver’,‘WebServer’)
      print ‘WebServer - adminserver created.’
    except UnsupportedOperationException, usoe:
      pass
    except WLSTException, wlse:
      pass
  else:
    print ‘WebServer - adminserver exists.’
  print ‘Setting SendServerHeaderEnabled = 0 for WebServer - adminserver’
  adminserver_WebServer_Obj.setSendServerHeaderEnabled(0)
  print ‘Setting MaxLogFileSizeKBytes = 0 for WebServer - adminserver’
  adminserver_WebServer_Obj.setMaxLogFileSizeKBytes(0)
  print ‘Setting LoggingEnabled = 1 for WebServer - adminserver’
  adminserver_WebServer_Obj.setLoggingEnabled(1)
  print ‘Setting LogFileName = /apps/opt/weblogic/config/ABCD/logs/adminserver_access.log for WebServer -
adminserver’
  adminserver_WebServer_Obj.setLogFileName(‘/apps/opt/weblogic/config/ABCD/logs/adminserver_access.log’)
  cd(‘/Server/adminserver’)
  print ‘Creating Log = adminserver for Server - adminserver’
  adminserver_Log_Obj = None
try:
    adminserver_Log_Obj = cd(‘Logs/adminserver’)
  except UnsupportedOperationException, usoe:
    pass
  except WLSTException, wlse:
    pass
  if adminserver_Log_Obj == None:
    try:
      adminserver_Log_Obj = create(‘adminserver’,‘Log’)
      print ‘Log - adminserver created.’
    except UnsupportedOperationException, usoe:
      pass
    except WLSTException, wlse:
      pass
  else:
    print ‘Log - adminserver exists.’
  print ‘Setting RotationType = none for Log - adminserver’
  adminserver_Log_Obj.setRotationType(‘none’)
  print ‘Setting FileName = /apps/opt/weblogic/config/ABCD/logs/adminserver.log for Log - adminserver’
  adminserver_Log_Obj.setFileName(‘/apps/opt/weblogic/config/ABCD/logs/adminserver.log’)
  cd(‘/’)
  return adminserver_Server_Obj
###
# Create Server - managed1
###
def Create_managed1_Server_Func( ):
  print ‘Creating Server = managed1’
  managed1_Server_Obj = None
  try:
    managed1_Server_Obj = cd(‘Servers/managed1’)
  except UnsupportedOperationException, usoe:
    pass
  except WLSTException, wlse:
    pass
  if managed1_Server_Obj == None:
    try:
      managed1_Server_Obj = create(‘managed1’,‘Server’)
      print ‘Server - managed1 created.’
    except UnsupportedOperationException, usoe:
      pass
    except WLSTException, wlse:
      pass
  else:
    print ‘Server - managed1 exists.’
  print ‘Setting TransactionLogFilePrefix = config/ABCD/TLOGs/ for Server - managed1’
  managed1_Server_Obj.setTransactionLogFilePrefix(‘config/ABCD/TLOGs/’)
  print ‘Setting NativeIOEnabled = 1 for Server - managed1’
  managed1_Server_Obj.setNativeIOEnabled(1)
  print ‘Setting EnabledForDomainLog = 0 for Server - managed1’
  managed1_Server_Obj.setEnabledForDomainLog(0)
  print ‘Setting MSIFileReplicationEnabled = 0 for Server - managed1’
  managed1_Server_Obj.setMSIFileReplicationEnabled(0)
  print ‘Setting ManagedServerIndependenceEnabled = 0 for Server - managed1’
  managed1_Server_Obj.setManagedServerIndependenceEnabled(0)
print ‘Setting ListenPort = 2111 for Server - managed1’
  managed1_Server_Obj.setListenPort(2111)
  print ‘Setting ListenAddress = 122.122.122.122 for Server - managed1’
  managed1_Server_Obj.setListenAddress(‘122.122.122.122’)
cd(‘/’)
  cd(‘/Server/managed1’)
  print ‘Creating ExecuteQueue = default for Server - managed1’
  default_ExecuteQueue_Obj = None
  try:
    default_ExecuteQueue_Obj = cd(‘ExecuteQueues/default’)
  except UnsupportedOperationException, usoe:
    pass
  except WLSTException, wlse:
    pass
  if default_ExecuteQueue_Obj == None:
    try:
      default_ExecuteQueue_Obj = create(‘default’,‘ExecuteQueue’)
      print ‘ExecuteQueue - default created.’
    except UnsupportedOperationException, usoe:
      pass
    except WLSTException, wlse:
      pass
  else:
    print ‘ExecuteQueue - default exists.’
  print ‘Setting ThreadCount = 30 for ExecuteQueue - default’
  default_ExecuteQueue_Obj.setThreadCount(30)
  cd(‘/Server/managed1’)
  print ‘Creating WebServer = managed1 for Server - managed1’
  managed1_WebServer_Obj = None
  try:
    managed1_WebServer_Obj = cd(‘WebServers/managed1’)
  except UnsupportedOperationException, usoe:
    pass
  except WLSTException, wlse:
    pass
  if managed1_WebServer_Obj == None:
try:
      managed1_WebServer_Obj = create(‘managed1’,‘WebServer’)
      print ‘WebServer - managed1 created.’
    except UnsupportedOperationException, usoe:
      pass
    except WLSTException, wlse:
      pass
  else:
    print ‘WebServer - managed1 exists.’
  print ‘Setting SendServerHeaderEnabled = 0 for WebServer - managed1’
  managed1_WebServer_Obj.setSendServerHeaderEnabled(0)
  print ‘Setting MaxLogFileSizeKBytes = 0 for WebServer - managed1’
  managed1_WebServer_Obj.setMaxLogFileSizeKBytes(0)
  print ‘Setting LoggingEnabled = 1 for WebServer - managed1’
  managed1_WebServer_Obj.setLoggingEnabled(1)
  print ‘Setting LogFileName = /apps/opt/weblogic/config/ABCD/logs/managed1_access.log for WebServer -
managed1’
  managed1_WebServer_Obj.setLogFileName(‘/apps/opt/weblogic/config/ABCD/logs/managed1_access.log’)
  cd(‘/Server/managed1’)
  print ‘Creating Log = managed1 for Server - managed1’
  managed1_Log_Obj = None
  try:
    managed1_Log_Obj = cd(‘Logs/managed1’)
  except UnsupportedOperationException, usoe:
    pass
  except WLSTException, wlse:
    pass
  if managed1_Log_Obj == None:
  try:
    managed1_Log_Obj = create(‘managed1’,‘Log’)
    print ‘Log - managed1 created.’
  except UnsupportedOperationException, usoe:
    pass
  except WLSTException, wlse:
    pass
  else:
    print ‘Log - managed1 exists.’
  print ‘Setting RotationType = none for Log - managed1’
  managed1_Log_Obj.setRotationType(‘none’)
  print ‘Setting FileName = /apps/opt/weblogic/config/ABCD/logs/managed1.log for Log - managed1’
  managed1_Log_Obj.setFileName(‘/apps/opt/weblogic/config/ABCD/logs/managed1.log’)
  cd(‘/’)
  return managed1_Server_Obj
###
# Create Server - managed2
###
def Create_managed2_Server_Func( ):
  print ‘Creating Server = managed2’
  managed2_Server_Obj = None
  try:
    managed2_Server_Obj = cd(‘Servers/managed2’)
  except UnsupportedOperationException, usoe:
    pass
  except WLSTException, wlse:
    pass
  if managed2_Server_Obj == None:
    try:
      managed2_Server_Obj = create(‘managed2’,‘Server’)
      print ‘Server - managed2 created.’
    except UnsupportedOperationException, usoe:
      pass
    except WLSTException, wlse:
      pass
  else:
    print ‘Server - managed2 exists.’
  print ‘Setting TransactionLogFilePrefix = config/ABCD/TLOGs/ for Server - managed2’
  managed2_Server_Obj.setTransactionLogFilePrefix(‘config/ABCD/TLOGs/’)
  print ‘Setting NativeIOEnabled = 1 for Server - managed2’
  managed2_Server_Obj.setNativeIOEnabled(1)
  print ‘Setting EnabledForDomainLog = 0 for Server - managed2’
  managed2_Server_Obj.setEnabledForDomainLog(0)
  print ‘Setting MSIFileReplicationEnabled = 0 for Server - managed2’
  managed2_Server_Obj.setMSIFileReplicationEnabled(0)
  print ‘Setting ManagedServerIndependenceEnabled = 0 for Server - managed2’
  managed2_Server_Obj.setManagedServerIndependenceEnabled(0)
print ‘Setting ListenPort = 1221 for Server - managed2’
  managed2_Server_Obj.setListenPort(1221)
  print ‘Setting ListenAddress = 122.122.122.122 for Server - managed2’
  managed2_Server_Obj.setListenAddress(‘122.122.122.122’)
cd(‘/’)
  cd(‘/Server/managed2’)
  print ‘Creating ExecuteQueue = default for Server - managed2’
  default_ExecuteQueue_Obj = None
  try:
    default_ExecuteQueue_Obj = cd(‘ExecuteQueues/default’)
  except UnsupportedOperationException, usoe:
    pass
  except WLSTException, wlse:
    pass
  if default_ExecuteQueue_Obj == None:
    try:
      default_ExecuteQueue_Obj = create(‘default’,‘ExecuteQueue’)
      print ‘ExecuteQueue - default created.’
    except UnsupportedOperationException, usoe:
      pass
    except WLSTException, wlse:
      pass
  else:
    print ‘ExecuteQueue - default exists.’
  print ‘Setting ThreadCount = 30 for ExecuteQueue - default’
  default_ExecuteQueue_Obj.setThreadCount(30)
  cd(‘/Server/managed2’)
  print ‘Creating WebServer = managed2 for Server - managed2’
  managed2_WebServer_Obj = None
  try:
    managed2_WebServer_Obj = cd(‘WebServers/managed2’)
  except UnsupportedOperationException, usoe:
    pass
  except WLSTException, wlse:
    pass
  if managed2_WebServer_Obj == None:
    try:
      managed2_WebServer_Obj = create(‘managed2’,‘WebServer’)
      print ‘WebServer - managed2 created.’
    except UnsupportedOperationException, usoe:
      pass
    except WLSTException, wlse:
      pass
  else:
    print ‘WebServer - managed2 exists.’
  print ‘Setting SendServerHeaderEnabled = 0 for WebServer - managed2’
  managed2_WebServer_Obj.setSendServerHeaderEnabled(0)
  print ‘Setting MaxLogFileSizeKBytes = 0 for WebServer - managed2’
  managed2_WebServer_Obj.setMaxLogFileSizeKBytes(0)
  print ‘Setting LoggingEnabled = 1 for WebServer - managed2’
  managed2_WebServer_Obj.setLoggingEnabled(1)
  print ‘Setting LogFileName = /apps/opt/weblogic/config/ABCD/logs/managed2_access.log for WebServer -
managed2’
  managed2_WebServer_Obj.setLogFileName(‘/apps/opt/weblogic/config/ABCD/logs/managed2_access.log’)
  cd(‘/Server/managed2’)
  print ‘Creating Log = managed2 for Server - managed2’
  managed2_Log_Obj = None
  try:
    managed2_Log_Obj = cd(‘Logs/managed2’)
  except UnsupportedOperationException, usoe:
    pass
  except WLSTException, wlse:
    pass
  if managed2_Log_Obj == None:
  try:
    managed2_Log_Obj = create(‘managed2’,‘Log’)
    print ‘Log - managed2 created.’
    except UnsupportedOperationException, usoe:
  pass
    except WLSTException, wlse:
  pass
    else:
  print ‘Log - managed2 exists.’
    print ‘Setting RotationType = none for Log - managed2’
  managed2_Log_Obj.setRotationType(‘none’)
  print ‘Setting FileName = /apps/opt/weblogic/config/ABCD/logs/managed2.log for Log - managed2’
  managed2_Log_Obj.setFileName(‘/apps/opt/weblogic/config/ABCD/logs/managed2.log’)
  cd(‘/’)
  return managed2_Server_Obj
###
# Create Cluster - ABCD_CLUSTER
###
def Create_ABCD_CLUSTER_Cluster_Func( ):
  print ‘Creating Cluster = ABCD_CLUSTER’
  ABCD_CLUSTER_Cluster_Obj = None
  try:
    ABCD_CLUSTER_Cluster_Obj = cd(‘Clusters/ABCD_CLUSTER’)
  except UnsupportedOperationException, usoe:
    pass
  except WLSTException, wlse:
    pass
  if ABCD_CLUSTER_Cluster_Obj == None:
    try:
      ABCD_CLUSTER_Cluster_Obj = create(‘ABCD_CLUSTER’,‘Cluster’)
      print ‘Cluster - ABCD_CLUSTER created.’
    except UnsupportedOperationException, usoe:
      pass
    except WLSTException, wlse:
      pass
  else:
    print ‘Cluster - ABCD_CLUSTER exists.’
  print ‘Setting ClusterAddress = 122.122.122.122:2111,122.122.122.122:1221 for Cluster - ABCD_CLUSTER’
  ABCD_CLUSTER_Cluster_Obj.setClusterAddress(‘122.122.122.122:2111,122.122.122.122:1221’)
  print ‘Setting DefaultLoadAlgorithm = round-robin for Cluster - ABCD_CLUSTER’
  ABCD_CLUSTER_Cluster_Obj.setDefaultLoadAlgorithm(‘round-robin’)
  print ‘Setting MulticastAddress = 12.12.12.12 for Cluster - ABCD_CLUSTER’
  ABCD_CLUSTER_Cluster_Obj.setMulticastAddress(‘12.12.12.12’)
  cd(‘/’)
  cd(‘/’)
  return ABCD_CLUSTER_Cluster_Obj
###
# Update Log - ABCD
###
def Update_ABCD_Log_Func( ):
  print ‘Updating Log = ABCD’
  ABCD_Log_Obj = None
  try:
    ABCD_Log_Obj = cd(‘Logs/ABCD’)
  except UnsupportedOperationException, usoe:
    pass
  except WLSTException, wlse:
    pass
  if ABCD_Log_Obj == None:
    try:
      ABCD_Log_Obj = create(‘ABCD’,‘Log’)
      print ‘Log - ABCD created.’
    except UnsupportedOperationException, usoe:
      pass
    except WLSTException, wlse:
      pass
  else:
    print ‘Log - ABCD exists.’
  print ‘Setting RotationType = none for Log - ABCD’
  ABCD_Log_Obj.setRotationType(‘none’)
  print ‘Setting FileName = /apps/opt/weblogic/config/ABCD/ABCD.log for Log - ABCD’
  ABCD_Log_Obj.setFileName(‘/apps/opt/weblogic/config/ABCD/ABCD.log’)
  cd(‘/’)
  cd(‘/’)
  return ABCD_Log_Obj
###
#Target Assignments
###
def end_func( ):
  print ‘Setting Cluster = Cluster:ABCD_CLUSTER for Server - managed2’
  assign(‘Server’,‘managed2’,‘Cluster’,‘ABCD_CLUSTER’)
  print ‘Setting Cluster = Cluster:ABCD_CLUSTER for Server - managed1’
  assign(‘Server’,‘managed1’,‘Cluster’,‘ABCD_CLUSTER’)
  print ‘Setting Targets = Target:managed1,managed2 for MailSession - XYZ Mail Session’
  assign(‘MailSession’,‘XYZ Mail Session’,‘Target’,‘managed1,managed2’)
###
#Call Functions
###
XYZ_Mail_Session_MailSession_Obj = Create_XYZ_Mail_Session_MailSession_Func( )
adminserver_Server_Obj = Create_adminserver_Server_Func( )
managed1_Server_Obj = Create_managed1_Server_Func( )
managed2_Server_Obj = Create_managed2_Server_Func( )
ABCD_CLUSTER_Cluster_Obj = Create_ABCD_CLUSTER_Cluster_Func( )
ABCD_Log_Obj = Update_ABCD_Log_Func( )
end_func( )
setOption(‘OverwriteDomain’,‘true’)
setOption(‘ServerStartMode’,‘prod’)
print ‘Writing domain to /apps/opt/weblogic/config/ABCD ...’
writeDomain(‘/apps/opt/weblogic/config/ABCD’)
print ‘Done.’
```

This script is then interpreted in step 419 by the interpreter 307 of FIG. 3, which in an exemplary embodiment is the WebLogic Scripting Tool (WLST). The WLST interpreter 307 generates the Weblogic domain and its configuration. It is noted that the interpreter 307 can operate in an offline mode and an online mode. Depending upon the configuration requirements, both WLST offline mode and WLST online mode may be utilized. The online WLST mode refers to being connected to an administration server or managed server instance, whereas the offline mode refers to configurations that are implemented without connecting to a WebLogic server. The templates used by the WLST interpreter 307 are customizable such that they conform to enterprise wide Weblogic standards—i.e., they define standard user names, passwords, roles etc. These programs are bundled in a shell script, which just takes the domain name as the argument; this is called to generate a WebLogic configuration.

Optionally, the process can apply a correction to the configuration (if the interpreter 307 is unable to handle all configuration parameters, for example), as in step 421. That is, direct editing of the configuration can be performed.

The above process can take place without the involvement of any other entity (besides the application team 107). In other words, the process provides the ability to directly implement server configurations while achieving uniformity and conformity to standards across the enterprise. Thus, there is no time wasted in requirements transfer and handoffs. Throughout the process, certain standards and key parameters are maintained. It is also useful to note that the configuration can be moved from one environment to another fairly easily—which is also the main benefit of using software bundles in the first place. The described process circumvents the disadvantages of creating software bundles. Furthermore, the process eliminates the need for the applications team 107 to have knowledge in specialized programming languages and various software components, as well as ensures that security and performance related parameters are set properly.

The above described processes relating to software management may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

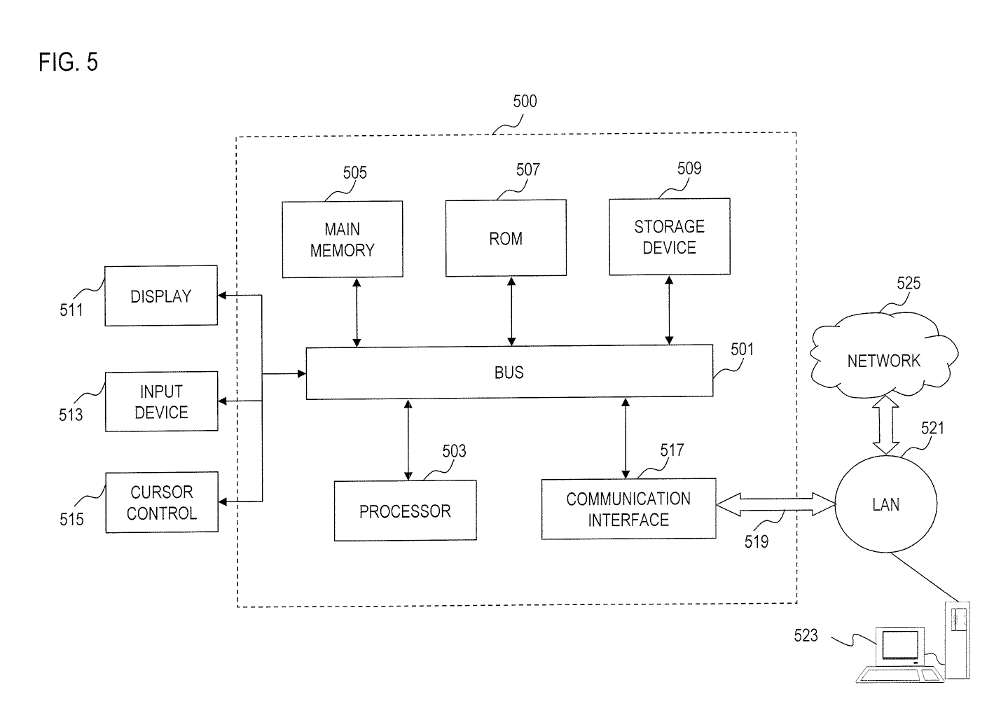

FIG. 5 illustrates a computer system 500 upon which an exemplary embodiment can be implemented. For example, the processes described herein can be implemented using the computer system 500. The computer system 500 includes a bus 501 or other communication mechanism for communicating information and a processor 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for controlling cursor movement on the display 511.

According to one embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the exemplary embodiment. Thus, exemplary embodiments are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an exemplary embodiment through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the various exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
building a system file that includes software environment information;
validating the system file against one or more rules; and
outputting a script used to generate standardized configuration information for the software environment.

2. A method according to claim 1, wherein the software environment information includes user identifiers, user roles, and corresponding passwords, further comprising:
encrypting the passwords for inclusion in the configuration information.

3. A method according to claim 1, further comprising:
interpreting the script to generate the configuration information.

4. A method according to claim 1, further comprising:
parsing the system file;
determining whether the parsed file includes a security or performance related parameter; and
adding the security or performance related parameter into the parsed file, if no security or performance related parameter has been specified.

5. A method according to claim 1, further comprising:
generating an error if the system file does not satisfy one or more of the rules, wherein the system file is modified in response to the error.

6. A method according to claim 1, wherein the configuration information includes a log file name and associated location.

7. A method according to claim 1, wherein the software environment is a production environment.

8. A method according to claim 1, wherein the system file specifies a list of components and corresponding properties of the components.

9. A method according to claim 1, wherein the system file is in an extensible mark-up language (XML) format and the script is a Jython script.

10. A method according to claim 1, wherein the configuration information corresponds to a server or a portal.

11. An apparatus comprising:
a processor configured to execute a build program configured to build a system file that includes software environment information, to execute a validation program and a code builder,
wherein the system file is transmitted to the validation program for validating the system file against one or more rules,
wherein the validated system is supplied to the code builder for outputting a script, the script being used to generate standardized configuration information for the software environment.

12. An apparatus according to claim 11, wherein the software environment information includes user identifiers, user roles, and corresponding passwords, the processor being further configured to encrypt the passwords for inclusion in the configuration information.

13. An apparatus according to claim 11, wherein the processor is further configured to execute an interpreter configured to interpret the script to generate the configuration information.

14. An apparatus according to claim 11, wherein the processor is further configured to parse the system file, to determine whether the parsed file includes a security or performance related parameter, and to add the security or performance related parameter into the parsed file, if no security or performance related parameter has been specified.

15. An apparatus according to claim 11, wherein the processor is further configured to generate an error if the system file does not satisfy one or more of the rules, wherein the system file is modified in response to the error.

16. An apparatus according to claim 11, wherein the configuration information includes a log file name and associated location.

17. An apparatus according to claim 11, wherein the software environment is a production environment.

18. An apparatus according to claim 11, wherein the system file specifies a list of components and corresponding properties of the components.

19. An apparatus according to claim 11, wherein the system file is in an extensible mark-up language (XML) format and the script is a Jython script.

20. An apparatus according to claim 11, wherein the configuration information corresponds to a server or a portal.

21. A computer-readable storage medium configured to store instructions for causing a processor to perform steps comprising:
building a system file that includes software environment information;
validating the system file against one or more rules; and
outputting a script used to generate standardized configuration information for the software environment.

22. A computer-readable storage medium according to claim 21, wherein the software environment information includes user identifiers, user roles, and corresponding passwords, and the steps further comprising:
encrypting the passwords for inclusion in the configuration information.

23. A computer-readable storage medium according to claim 21, wherein the steps further comprises:
interpreting the script to generate the configuration information.

24. A computer-readable storage medium according to claim 21, wherein the steps further comprises:
parsing the system file;
determining whether the parsed file includes a security or performance related parameter; and
adding the security or performance related parameter into the parsed file, if no security or performance related parameter has been specified.

25. A computer-readable storage medium according to claim 21, wherein the steps further comprises:
generating an error if the system file does not satisfy one or more of the rules, wherein the system file is modified in response to the error.
